(19) United States
(12) Patent Application Publication
(10) Pub. No.: US 2015/0076299 A1
(43) Pub. Date: Mar. 19, 2015

(54) Vacuum mount type support structure

(71) Applicant: Cheng-Che Yu, Taipei (TW)

(72) Inventor: Cheng-Che Yu, Taipei (TW)

(21) Appl. No.: 13/987,889

(22) Filed: Sep. 13, 2013

(51) Int. Cl. F16M 13/02; B60R 11/02; B60R 11/00

(52) U.S. Cl. CPC F16M 13/022; B60R 11/00; B60R 11/02; B60R 2011/0056
USPC 248/205.8

(57) ABSTRACT

A vacuum mount type support structure includes a vacuum mount type support structure of the present invention comprises a bracket, a vacuum mount peripherally sealed to the bracket and attachable to a flat surface and partially movable up and down relative to the bracket to produce a vacuum in between the vacuum mount and the attached flat surface, an operating device comprising an actuation member made in the form of a driving screw or cam wheel and rotatable to move the vacuum mount up and down relative to the bracket, and a support arm mounted at the bracket around the operating device for holding an electronic device and formed of multiple segments that are pivotally coupled to one another and adjustable to change the elevation and angular position of the supported electronic device.

### BACKGROUND OF THE INVENTION

1. Field of the Invention

The present invention relates to support devices and more particularly, to a vacuum mount type support structure, which is detachably mountable at a flat surface of an object to support an electronic device, allowing adjustment of the elevation and angular position of the supported electronic device directly and conveniently.

2. Description of the Related Art

Many vacuum mount type and plug type support devices are commercially available for mounted on the windshield or rear-view mirror of a motor vehicle or a flat surface of an object to support a an electronic device such as smart phone, car video recorder, computer, or LCD display device. When going to adjust the direction or angle of the supported electronic device, the user must dismount the support device and then mount the support device at the selected location in the selected angular position. This adjustment procedure is complicated.

### SUMMARY OF THE INVENTION

The objective of the present invention is to provide a vacuum mount type support structure, which is detachably mountable at a flat surface of an object to support an electronic device, allowing adjustment of the elevation and angular position of the supported electronic device directly and conveniently.

To achieve this and other objects of the present invention, a vacuum mount type support structure of the present invention comprises a bracket, a vacuum mount peripherally sealed to the bracket and attachable to a flat surface and partially movable up and down relative to the bracket to produce a vacuum in between the vacuum mount and the attached flat surface, an operating device comprising an actuation member made in the form of a driving screw or cam wheel and rotatable to move the vacuum mount up and down relative to the bracket, and a support arm mounted at the bracket around the operating device and adapted to hold an external electronic device.

Further, the support arm is formed of multiple segments that are pivotally coupled to one another and adjustable to change the elevation and angular position of the supported electronic device.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a vacuum mount type support structure in accordance with the present invention.

FIG. 2 is an exploded view of the vacuum mount type support structure in accordance with the present invention.

FIG. 3 is a sectional view of the vacuum mount type support structure in accordance with the present invention.

FIG. 4 is an elevational view of an alternate form of the vacuum mount type support structure in accordance with the present invention.

FIG. 5 is an exploded view of the vacuum mount type support structure shown in FIG. 4.

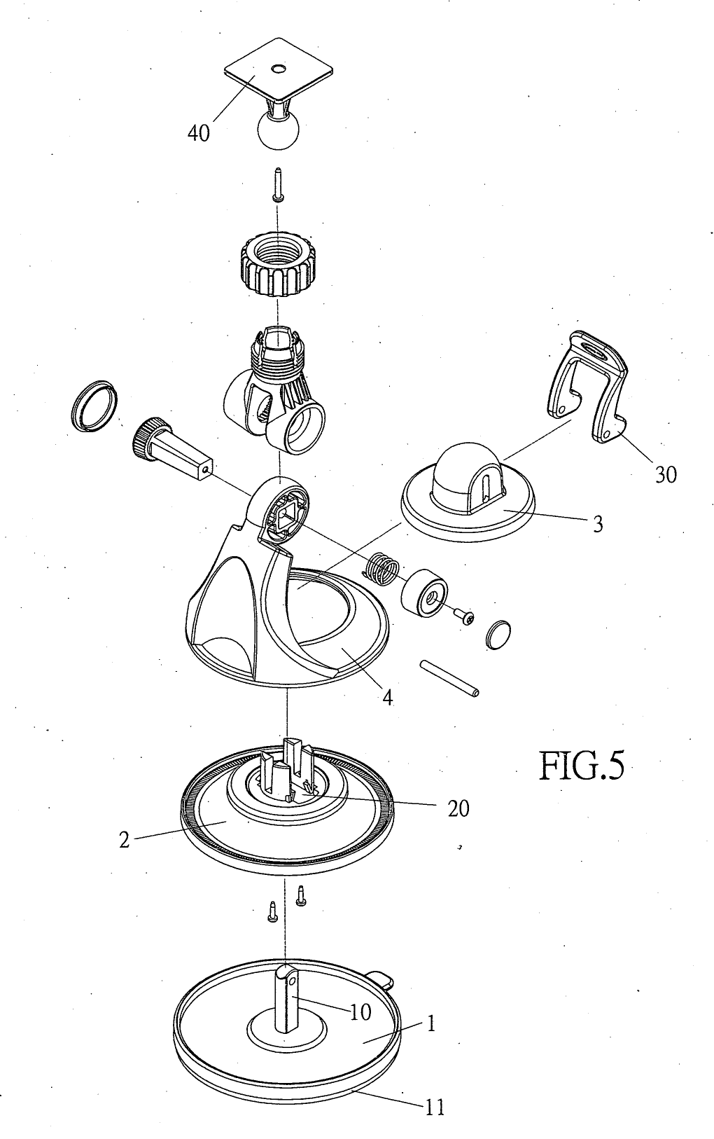

FIG. 6 is a sectional view of the vacuum mount type support structure shown in FIG. 4.

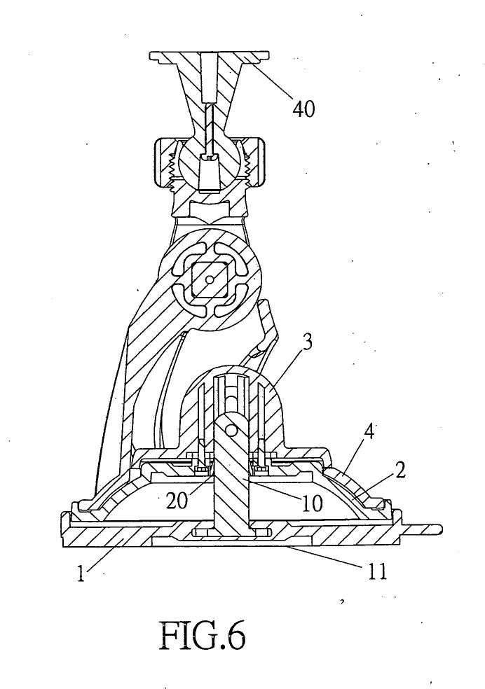

### DETAILED DESCRIPTION OF THE PREFERRED EMBODIMENT

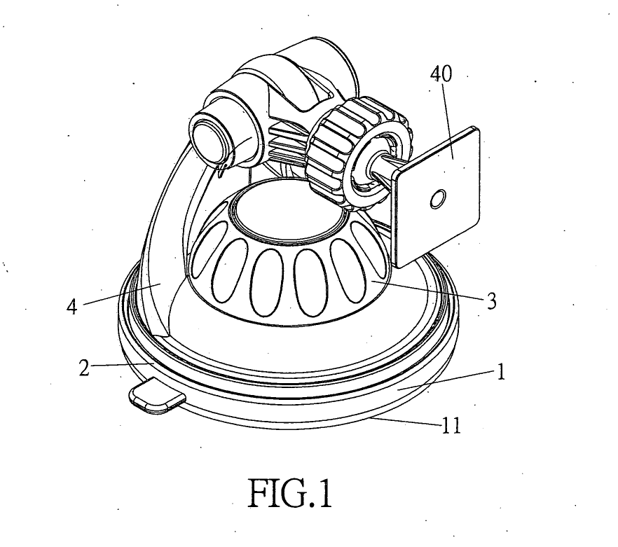

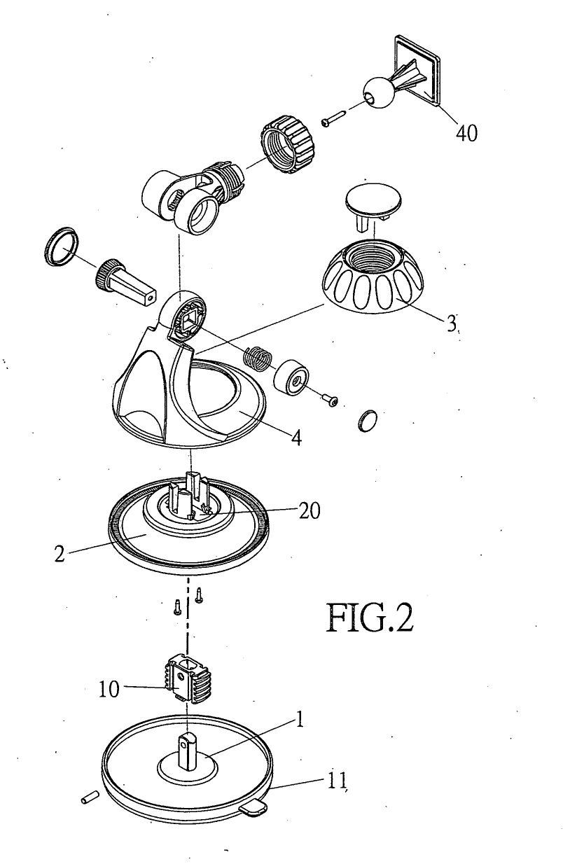

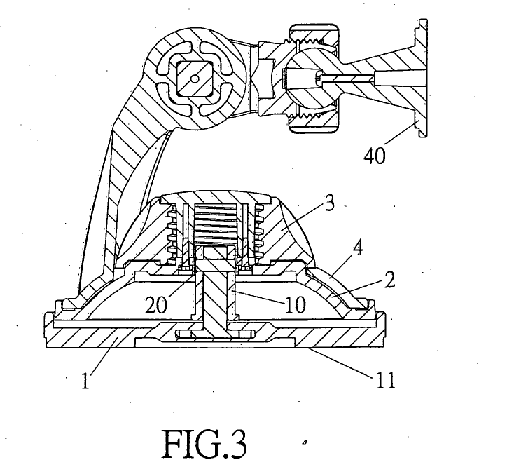

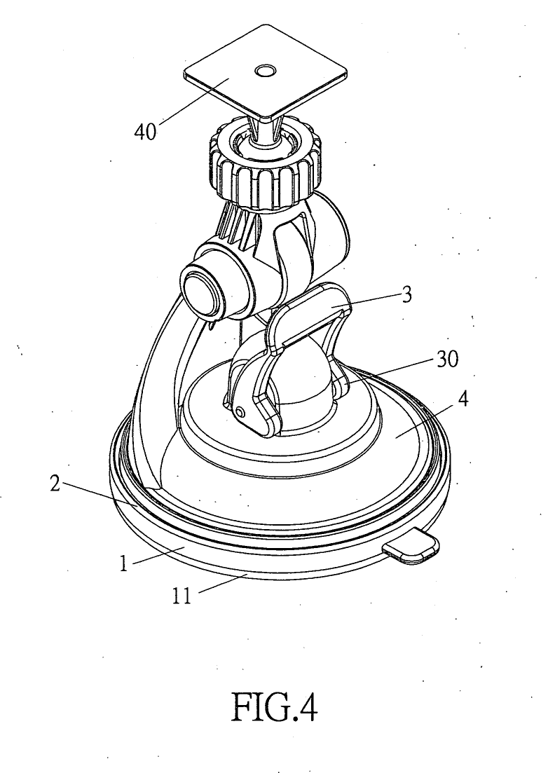

Referring to FIGS. 1-4, a vacuum mount type support structure in accordance with the present invention is shown comprising a vacuum mount 1, a bracket 2, an operating device 3, and a support arm 4.

The vacuum mount 1 comprises a polygonal supporting bar 10 disposed at a top side thereof, and a rubber suction disk 11 located at a bottom side thereof. The rubber suction disk 11 is peripherally sealed to the bracket 2. The polygonal connection bar 10 is inserted through a center through hole 20 of the bracket 2. The bracket 2 is a dome-like hard frame shell. The operating device 3 is mounted at the top side of the bracket 2, comprising an actuation member 30 operable to carry the polygonal connection bar 10 up and down. The support arm 4 is mounted at the bracket 2 around the operating device 3, comprising a device holder 40 adapted to hold an electronic device. Further, the support arm 4 can be formed of multiple segments that are pivotally coupled to one another and can be adjusted to change the elevation and angular position of the supported electronic device.

Further, in the embodiment shown in FIGS. 1-4, the actuation member 30 is a screw member horizontally rotatable to move polygonal connection bar 10 upward or downward relative to the bracket 2. In the embodiment shown in FIGS, 5 and 6, the actuation member 30 is a cam wheel vertically rotatable in reversed directions to move polygonal connection bar 10 of the vacuum mount 1 upward or downward relative to the bracket 2.

Because the polygonal connection bar 10 of the vacuum mount 1 is inserted through a center through hole 20 of the bracket 2 and connected to the operating device 3, the user can operate the operating device 3 to rotate the actuation member (screw member or cam wheel) 30 conveniently and to further move the polygonal connection bar 10 up and down. When pulling the polygonal connection bar 10 upwardly toward the bracket 2 after attachment of the rubber suction disk 11 of the vacuum mount 1 to a flat surface of a ceramic wall, glass, or any other object, a vacuum is produced between the rubber suction disk 11 and the flat surface, causing the vacuum mount 1 to be fixedly secured to the flat surface. On the contrary, when the polygonal connection bar 10 is moved downwardly in direction away from the bracket 2, the vacuum is disappeared, allowing removable of the rubber suction disk 11 from the flat surface.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A vacuum mount type support structure, comprising:
a bracket being a dome-like hard frame shell, said bracket comprising a center through hole;
a vacuum mount comprising a polygonal supporting bar disposed at a top side thereof and a rubber suction disk located at a bottom side thereof, said rubber suction disk being peripherally sealed to said bracket and attachable to a flat surface and partially movable up and down relative to said bracket to produce a vacuum in between said rubber suction disk and the attached flat surface, said polygonal connection bar being inserted through said center through hole of said bracket;
an operating device mounted at a top side of said bracket, said operating device comprising a driving screw coupled to said polygonal connection bar and horizontally rotatable to move said polygonal connection bar up and down; and
a support arm mounted at said bracket around said operating device, said support arm comprising a device holder adapted to hold an external electronic device.

2. The vacuum mount type support structure as claimed in claim 1, wherein said support arm is formed of multiple segments that are pivotally coupled to one another and adjustable to change the elevation and angular position of the supported electronic device.

3. A vacuum mount type support structure, comprising:
a bracket being a dome-like hard frame shell, said bracket comprising a center through hole;
a vacuum mount comprising a polygonal supporting bar disposed at a top side thereof and a rubber suction disk located at a bottom side thereof, said rubber suction disk being peripherally sealed to said bracket and attachable to a flat surface and partially movable up and down relative to said bracket to produce a vacuum in between said rubber suction disk and the attached flat surface, said polygonal connection bar being inserted through said center through hole of said bracket;
an operating device mounted at a top side of said bracket, said operating device comprising a cam wheel coupled to said polygonal connection bar and vertically rotatable to move said polygonal connection bar up and down; and
a support arm mounted at said bracket around said operating device, said support arm comprising a device holder adapted to hold an external electronic device.

4. The vacuum mount type support structure as claimed in claim 3, wherein said support arm is formed of multiple segments that are pivotally coupled to one another and adjustable to change the elevation and angular position of the supported electronic device.
